(19) United States
(12) Patent Application Publication
(10) Pub. No.: US 2026/0237953 A1
(43) Pub. Date: Aug. 13, 2026

(54) CONNECTOR MATING TOOL WITH MATING FEEDBACK

(71) Applicant: TE Connectivity Solutions GmbH, Schaffhausen (CH)

(72) Inventors: Younghwan Lee, Troy, MI (US); Galen M. Martin, Middletown, PA (US); Nathan Philip Myer, Middletown, PA (US)

(21) Appl. No.: 19/052,547

(22) Filed: Feb. 13, 2025

(51) Int. Cl. H01R 43/26

(52) U.S. Cl. CPC H01R 43/26

(57) ABSTRACT

A connector mating tool to assist mating an electrical connector with a mating electrical connector in a mating direction includes a base and a support arm extending from the base with a press surface configured to engage the electrical connector and press the electrical connector in the mating direction. The connector mating tool includes a latch pad extending from the support arm. The latch pad is configured to be aligned with a latch of the electrical connector. The connector mating tool includes a latch feedback device on the latch pad configured to interface with the latch when the latch is actuated to provide feedback regarding a position of the latch.

### BACKGROUND OF THE INVENTION

The subject matter herein relates generally to connector mating tools.

Electrical connectors are widely used in various industries, including automotive, aerospace, consumer electronics, and industrial automation, to establish reliable electrical connections between circuits. These connectors are critical for ensuring uninterrupted power and signal transmission in a variety of applications. As such, the proper alignment, engagement, and secure locking of connectors are essential to prevent issues such as intermittent connections, short circuits, or complete disconnection during operation.

In many applications, particularly those subjected to vibration, temperature variations, or other environmental stresses, improper mating or incomplete engagement of electrical connectors can result in system malfunctions or failures. To address these challenges, connector systems often include mechanical locking mechanisms, such as latches, to ensure that the connectors remain securely mated during use. However, relying solely on these locking mechanisms may not provide sufficient assurance that the connectors are fully seated or properly aligned before the locking process is complete.

To improve the reliability of electrical connections, some connector designs incorporate Connector Position Assurance (CPA) devices. A CPA device is typically a secondary mechanism that confirms the proper alignment and engagement of the connector components. The CPA device provides a visual indication to the installer that the electrical connectors are properly mated. Existing CPA devices, while effective, may suffer from certain limitations. For instance, some designs are cumbersome to operate, adding complexity to the assembly process. Additionally, the CPA devices increase the overall cost of the electrical connector.

Consequently, there is a need for improved electrical connector systems that offer reliability, ease of use, and assurance of proper mating of electrical connectors.

### BRIEF DESCRIPTION OF THE INVENTION

In one embodiment, a connector mating tool to assist mating an electrical connector with a mating electrical connector in a mating direction is provided. The connector mating tool includes a base. The connector mating tool includes a support arm extending from the base. The support arm includes a press surface configured to engage the electrical connector and press the electrical connector in the mating direction. The connector mating tool includes a latch pad extending from the support arm. The latch pad is configured to be aligned with a latch of the electrical connector. The connector mating tool includes a latch feedback device on the latch pad configured to interface with the latch when the latch is actuated to provide feedback regarding a position of the latch.

In another embodiment, a connector mating tool to assist mating an electrical connector with a mating electrical connector in a mating direction is provided. The connector mating tool includes a base. The connector mating tool includes a support arm extending from the base. The support arm includes a press surface configured to engage the electrical connector and press the electrical connector in the mating direction. The connector mating tool includes a latch pad extending from the support arm. The latch pad is configured to be aligned with a latch of the electrical connector. The connector mating tool includes a latch feedback device on the latch pad configured to interface with the latch when the latch is actuated to provide feedback regarding a position of the latch. The connector mating tool includes a visual indicator on one of the base or the support arm. The visual indicator is operably coupled to the latch feedback device. The visual indicator provides a visual indication of an operation status of the latch feedback device.

In a further embodiment, a connector mating tool to assist mating an electrical connector with a mating electrical connector in a mating direction is provided. The connector mating tool includes a base. The connector mating tool includes a support arm extending from the base. The support arm includes a press surface configured to engage the electrical connector and press the electrical connector in the mating direction. The connector mating tool includes a latch pad extending from the support arm. The latch pad is configured to be aligned with a latch of the electrical connector. The connector mating tool includes a latch feedback device on the latch pad configured to interface with the latch when the latch is actuated to provide feedback regarding a position of the latch. The connector mating tool includes a cover coupled to at least one of the support arm and the latch pad. The cover is movable between a covered position and an uncovered position. The cover is configured to cover the latch feedback device in the covered position. The latch feedback device is accessible to interface with the latch when the cover is in the uncovered position.

### BRIEF DESCRIPTION OF THE DRAWINGS

FIG. 1 is a rear perspective view of connector mating tools in accordance with an exemplary embodiment used for mating electrical connectors with mating electrical connectors (not shown).

FIG. 2 is a front perspective view of the electrical connectors 100 and the connector mating tools 200 in accordance with an exemplary embodiment

FIG. 3 is a perspective view of the connector mating tool in accordance with an exemplary embodiment.

FIG. 4 is a rear perspective view of the connector mating tool coupled to the electrical connector in accordance with an exemplary embodiment.

FIG. 5 is a cross-sectional view of the connector mating tool coupled to the electrical connector showing the latch in the normal or latched position in accordance with an exemplary embodiment.

FIG. 6 is a cross-sectional view of the connector mating tool coupled to the electrical connector showing the latch in the actuated or unlatched position in accordance with an exemplary embodiment.

FIG. 7 is an enlarged cross-sectional view of a portion of the connector mating tool and electrical connector unmated from the mating electrical connector in accordance with an exemplary embodiment.

FIG. 8 is an enlarged cross-sectional view of a portion of the connector mating tool and electrical connector mated to the mating electrical connector in accordance with an exemplary embodiment.

FIG. 9 is an enlarged cross-sectional view of a portion of the connector mating tool and electrical connector partially mated with the mating electrical connector in accordance with an exemplary embodiment.

FIG. 10 is an enlarged cross-sectional view of a portion of the connector mating tool and electrical connector unmated to the mating electrical connector in accordance with an exemplary embodiment.

FIG. 11 is an enlarged cross-sectional view of a portion of the connector mating tool and electrical connector partially mated with the mating electrical connector in accordance with an exemplary embodiment.

FIG. 12 is an enlarged cross-sectional view of a portion of the connector mating tool and electrical connector mated to the mating electrical connector in accordance with an exemplary embodiment.

### DETAILED DESCRIPTION OF THE INVENTION

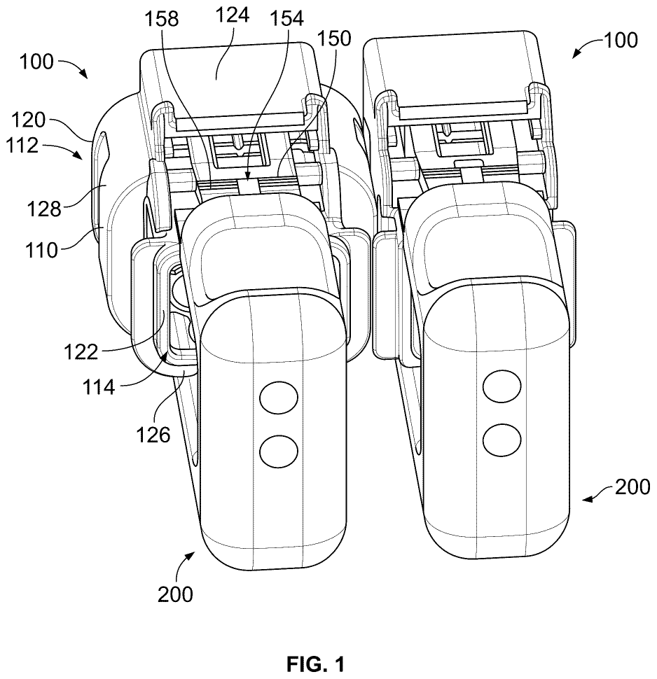

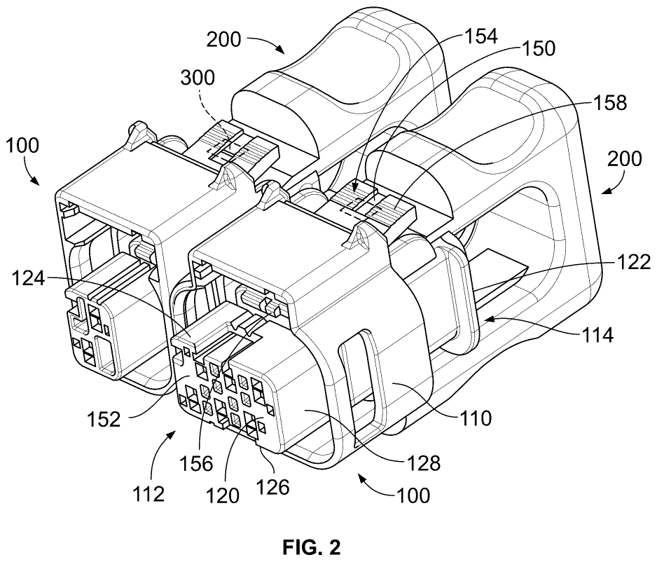

FIG. 1 is a rear perspective view of connector mating tools 200 in accordance with an exemplary embodiment used for mating electrical connectors 100 with mating electrical connectors (not shown). FIG. 2 is a front perspective view of the electrical connectors 100 and the connector mating tools 200 in accordance with an exemplary embodiment. The connector mating tools 200 are used to assist mating of the electrical connectors 100 with the corresponding mating electrical connectors in a mating direction for mating assistance during a mating process. In an exemplary embodiment, connector mating tools 200 provide mating feedback to the installer to ensure proper or full mating of the electrical connectors 100 with the mating electrical connectors. The connector mating tools 200 are designed to facilitate the secure and efficient mating of the electrical connector 100 with the corresponding mating electrical connector. The connector mating tools 200 are suited for applications where precise alignment, controlled engagement force, and ease of operation are desired, such as in automotive, aerospace, and industrial environments.

The connector mating tools 200 may be hand-held tools configured to be held by an installer to aide in mating by pushing the electrical connectors 100 into full engagement with the mating electrical connectors. In other various embodiments, the connector mating tools 200 may be arranged at an end of a robot or other automated assembly machine configured to pick and/or place the electrical connector 100 during the mating process.

In various embodiments, the connector mating tools 200 may be identical; however, the electrical connectors 100 may be different. As such, the same connector mating tool 200 may be utilized with different electrical connectors 100. For example, the electrical connectors 100 may include similar features to allow the same connector mating tool 200 to be utilized for mating assistance. In other various embodiments, different connector mating tools 200 may be provided for mating different electrical connectors 100, such as changing a size and/or a shape of the connector mating tool 200 to accommodate the different size/shape electrical connectors 100.

The connector mating tool 200 is designed to engage with the electrical connector 100. The connector mating tool 200 may include locating or alignment features to position the connector mating tool 200 relative to the electrical connector 100 to ensure proper orientation and controlled application of force during the mating process. The connector mating tool 200 incorporates features to verify complete engagement.

While two different types of electrical connectors 100 are shown in FIGS. 1 and 2, the connector mating tool 200 may be used with many other types of electrical connectors 100 and the electrical connectors 100 shown in FIGS. 1 and 2 are illustrative and non-limiting examples. The electrical connectors 100 include similar features and are described generically below.

The electrical connector 100 is configured to transmit data and/or power between the components. In an exemplary embodiment, the electrical connector 100 is a cable connector configured to be provided at ends of cables. However, the electrical connector 100 may be a board connector configured to be terminated to a printed circuit board. The electrical connector 100 may be a plug connector configured to be plugged into the mating electrical connector. In alternative embodiments, the electrical connector 100 may be a receptacle connector or header connector configured to receive a mating end of the mating electrical connector. The electrical connector 100 holds contacts (not shown), such as signal contacts, ground contacts, power contacts, and the like.

The electrical connector 100 includes a housing 110 configured to hold electrical contacts. The housing 110 may be manufactured from a dielectric material, such as a plastic material. For example, the housing 110 may be a molded plastic part, such as an injection molded part. The housing 110 extends between a mating end 112 and a cable end 114. The mating end 112 is configured to be mated with the mating electrical connector. The cables (not shown) are configured to extend from the cable end 114. In the illustrated embodiment, the housing 110 is a pass through connector having the cable end 114 opposite the mating end 112. In an alternative embodiment, the housing 110 may be a right angle housing having the cable end 114 perpendicular to the mating end 112.

In an exemplary embodiment, the housing 110 includes a front 120 and a rear 122 opposite the front 120. The housing 110 includes a top 124 and a bottom 126 opposite the top 124. The housing 110 includes sides 128 extending between the front 120 and the rear 122 and between the top 124 and the bottom 126. In the illustrated embodiment, the mating end 112 is located at the front 120 and the cable end 114 is located at the rear 122. The mating end 112 defines a separable mating interface for mating with the mating electrical connector. The mating end 112 may be plugged into the mating electrical connector.

In an exemplary embodiment, the housing 110 includes a latch 150. The latch 150 is used to latchably couple the electrical connector 100 to the mating electrical connector. The latch 150 is a deflectable latch configured to be moved between a normal or latched position and an actuated or unlatched position. For example, the latch 150 may be actuated (for example, pressed) from the latched position to the actuated position to release the latch 150 from a latching element of the mating electrical connector. The latch 150 may be released to return to the latched or normal position. In the illustrated embodiment, the latch 150 is located at the top 124 of the housing 110. The latch 150 may be located at other locations in alternative embodiments.

The latch 150 extends between a latching end 152 and an actuating end 154. The latching end 152 includes a latching element 156, such as a latching finger, configured to latchably engage the mating electrical connector. The latching element 156 may be located at the distal end (for example, front) of the latch 150. The latching element 156 may be located at a bottom surface of the latch 150. The latch 150 includes an actuator 158, such as a press tab, configured to be pressed by the operator to actuate and move the latch between the normal or released position and the actuated position. A bottom of the actuator 158 may be moved toward the top 124 of the housing 110 when actuated. The actuator 158 may be located at the rear of the latch 150.

In an exemplary embodiment, the connector mating tool 200 is configured to interface with the housing 110 and/or the latch 150. For example, the connector mating tool 200 may be configured to engage the rear 122 of the housing 110 to press the housing 110 in a forward mating direction. The connector mating tool 200 may engage the top 124 of the housing 110. For example, a portion of the connector mating tool 200 may be located in the space between the top 124 of the housing 110 and the bottom of the latch 150. The latch 150 is configured to interface with the connector mating tool 200. For example, when the latch 150 is actuated, the latch 150 may interface with the connector mating tool 200.

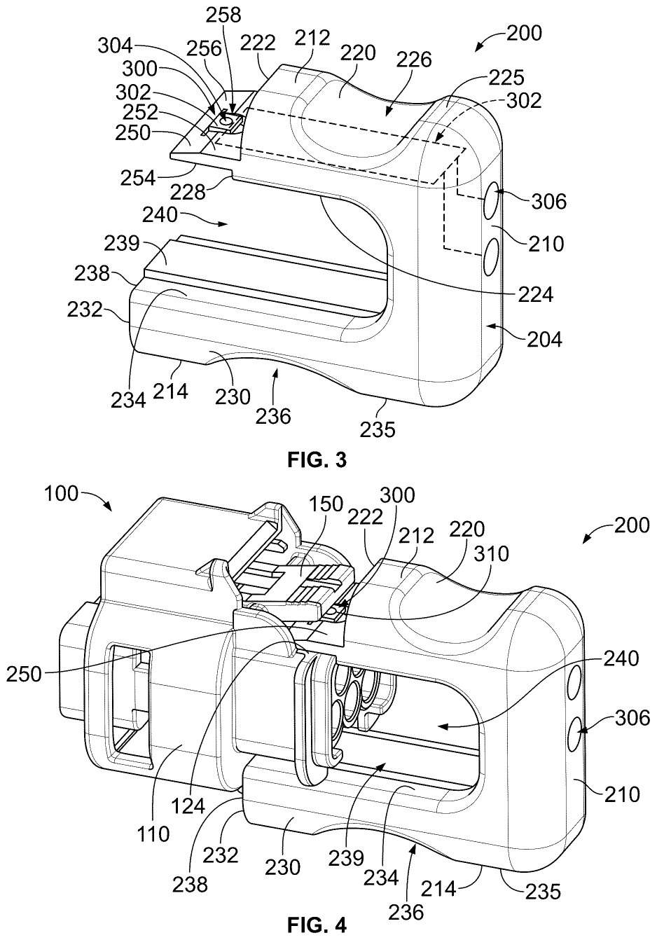

In an exemplary embodiment, the connector mating tool 200 includes a latch feedback device 300 (shown in FIG. 3), which provides feedback to the installer to verify proper mating between the connectors. For example, the latch feedback device 300 may provide feedback as to a position of the latch 150 to verify proper mating of the connectors. In an exemplary embodiment, the latch feedback device 300 determines when the latch 150 is in the unlatched or actuated position and when the latch 150 is in the latched position. For example, during mating, the latch 150 is moved to the actuated position, such as to clear the latching feature (for example, catch) of the mating electrical connector and is released to the latched position after the latching element 156 clears the latching feature of the mating electrical connector. The latch feedback device 300 is able to verify the positioning of the latch to determine when the latching element 156 is in the latched position and thus the connectors are fully and properly mated. In an exemplary embodiment, the latch feedback device 300 provides feedback to the installer, such as in the form of visual feedback, audible feedback, tactile feedback, haptic feedback, electronic feedback, or other type of feedback. The feedback may be provided at the connector mating tool 200 itself or may be transmitted remotely, such as wirelessly, to another device, such as a computer, user work station, handheld device, or other remote device.

FIG. 3 is a perspective view of the connector mating tool 200 in accordance with an exemplary embodiment. FIG. 4 is a rear perspective view of the connector mating tool 200 coupled to the electrical connector 100. The connector mating tool 200 is used to assist mating of the electrical connector 100 with the mating electrical connector in a mating direction. In an exemplary embodiment, the connector mating tool 200 provides feedback to the installer to verify proper mating between the connectors. For example, the latch feedback device 300 provides feedback as to a position of the latch 150 to verify proper mating of the connectors.

The connector mating tool 200 includes a structural frame 204 for installing the electrical connector 100. The structural frame 204 is used to install and press the electrical connector 100 in the mating direction during the mating process. The structural frame 204 may be configured for manual or automating operation and use. In various embodiments, the structural frame 204 is ergonomically designed for ease of use. For example, the structural frame 204 forms a handle for holding the electrical connector 100. In an exemplary embodiment, the structural frame is made of a durable material, such as reinforced plastic or metal, to withstand repeated use and environmental stresses.

In an exemplary embodiment, the structural frame 204 of the connector mating tool 200 includes a base 210 and one or more support arms for supporting the connector mating tool 200 relative to the housing 110 of the electrical connector 100. In the illustrated embodiment, the connector mating tool 200 includes a first support arm 220 extending from a top 212 of the base 210 and a second support arm 230 extending from a bottom 214 of the base 210. The connector mating tool 200 may include greater or fewer support arms in alternative embodiments. The support arms 220, 230 are spaced apart from each other to interface with different portions of the electrical connector 100. A receiving space 240 is defined between the support arms 220, 230, such as forward of the base 210. The receiving space 240 is configured to receive a portion of the electrical connector 100. The structural frame 204 may be U-shaped with the base 210 extending between the support arms 220, 230 and with the support arms 220, 230 extending from opposite ends of the base 210. The structural frame 204 may have other shapes in alternative embodiments.

In an exemplary embodiment, the support arms 220, 230 are integral with the base 210. For example, the support arms 220, 230 and the base 210 are co-molded to form a unitary, monolithic structural frame 204. In alternative embodiments, the support arms 220, 230 may be separate from the base 210 and coupled thereto. In various embodiments, the base 210 may be held by the installer and pushed forward in the mating direction during the installation process. For example, the base 210 may be handheld. In other various embodiments, the base 210 may be mounted to an automated device or machine that is used to install the electrical connector one hundred. For example, the base 210 may be mounted to an end of the robot arm, such as a multi-axis robot arm and is movable in three-dimensional space to manipulate the connector mating tool 200, such as to pick up the electrical connector 100 and mate the electrical connector 100 with the mating electrical connector.

The first support arm 220 is located at the top of the structural frame 204. The support arm 220 extends forward from the base 210 to a distal end 222 at a front of the support arm 220. The support arm 220 includes an inner surface 224 (for example, bottom) facing the receiving space 240 and an outer surface 225 (for example, top) facing outward. In an exemplary embodiment, the support arm 220 includes a finger grip 226 along the outer surface 225. The finger grip 226 provides an area for holding the connector mating tool 200.

In an exemplary embodiment, the support arm 220 includes one or more press surfaces 228 configured to engage the electrical connector 100 and press the electrical connector 100 in the mating direction. In the illustrated embodiment, the press surface 228 is located at the front of the support arm 220. The press surface 228 is forward facing. The press surface 228 may include a vertical wall. The press surface 228 may have other shapes or orientations in alternative embodiments. The support arm 220 may include one or more alignment features, such as at the press surface 228, to align or position the connector mating tool 200 relative to the electrical connector 100. The alignment features may include protrusions, tabs, posts, grooves, slots, openings, or other types of alignment features configured to interface with the electrical connector 100 to position the support arm 220 relative to the electrical connector 100.

The second support arm 230 is located at the bottom of the structural frame 204. The support arm 230 extends forward from the base 210 to a distal end 232 at a front of the support arm 230. The support arm 230 includes an inner surface 234 (for example, top) facing the receiving space 240 and an outer surface 235 (for example, bottom) facing outward. In an exemplary embodiment, the support arm 230 includes a finger grip 236 along the outer surface 235. The finger grip 236 provides an area for holding the connector mating tool 200.

In an exemplary embodiment, the support arm 230 includes one or more press surfaces 238 configured to engage the electrical connector 100 and press the electrical connector 100 in the mating direction. In the illustrated embodiment, the press surface 238 is located at the front of the support arm 230. The press surface 238 is forward facing. The press surface 238 may include a vertical wall. The press surface 238 may have other shapes or orientations in alternative embodiments. The support arm 230 may include one or more alignment features 239, such as at the press surface 238, to align or position the connector mating tool 200 relative to the electrical connector 100. The alignment features may include protrusions, tabs, posts, grooves, slots, openings, or other types of alignment features configured to interface with the electrical connector 100 to position the support arm 230 relative to the electrical connector 100. In the illustrated embodiment, the alignment feature 239 is a rail extending along the inner surface 234 of the support arm 230. The rail may be used to hold a side to side position of the support arm 230 relative to the electrical connector 100.

In an exemplary embodiment, the connector mating tool 200 includes a latch pad 250 extending from the first support arm 230. The latch pad 250 is configured to be aligned with the latch 150 of the electrical connector 100. For example, the latch pad 250 may be received in the space between the top 124 of the housing 110 and the bottom of the latch 150. In the illustrated embodiment, the latch pad 250 extends forward from the distal end 222 of the support arm 220. The latch pad 250 may be oriented generally horizontally. The latch pad 250 includes an upper surface 252 and a lower surface 254. Optionally, the upper surface 252 may be tapered at the front end thereof to form a ramp 256. In an exemplary embodiment, the latch pad 250 includes a pocket 258 in the upper surface 252. The pocket 258 receives the latch feedback device 300. In alternative embodiments, rather than having a separate latch pad 250 extending forward of the first support arm 230, the top of the first support arm 230 may define the latch pad 250. For example, the first support arm 230 may be received in the space between the top 124 of the housing 110 and the bottom of the latch 150.

The latch feedback device 300 is provided on the latch pad 250. For example, the latch feedback device 300 is received in the pocket 258 at the upper surface 252 of the latch pad 250. The latch feedback device 300 is configured to interface with the latch 150 when the latch 150 is actuated to provide feedback regarding a position of the latch 150. In an exemplary embodiment, the latch feedback device 300 provides feedback to the installer, such as in the form of visual feedback, audible feedback, tactile feedback, electronic feedback, or other type of feedback. The feedback may be provided at the connector mating tool 200 itself or may be transmitted remotely, such as wirelessly, to another device, such as a computer, user work station, handheld device, or other remote device.

In an exemplary embodiment, the latch feedback device 300 includes a feedback circuit 302. The feedback circuit 302 includes an input device 304 and an output device 306. The input device 304 receives feedback from the electrical connector 100, such as from the latch 150. For example, the input device 304 receives input based on a position of the latch 150. The input device 304 may determine when the latch 150 is in the actuated position (unlatched position) and/or when the latch 150 is in the released position (latched position). As such, the input device 304 receives input relating to a mated status of the electrical connector 100. For example, the input device 304 receives input when the latch 150 is released to the latched position thus verifying that the electrical connector 100 is fully mated and latched to the mating electrical connector. The output device 306 provides a status indication to the installer. The output device 306 may provide a visual output, an audible output, a tactile output, an electronic output, or other type of output. For example, the output device 306 may include a light, such as an LED, to provide a visual feedback. The output device 306 may include a display displaying words, numbers, symbols or other indicators to provide visual feedback. The output device 306 may include an alarm or speaker to provide an audible output. The output device 306 may include a vibration element or vibration motor to provide tactile or haptic feedback. The output may be provided at the connector mating tool 200, such as at the base 210 and/or the support arms 220, 230. The output may be transmitted remotely, such as wirelessly, to another device.

In an exemplary embodiment, the latch feedback device 300 includes a switch 310 configured to be activated by the latch 150. The switch 310 is connected to the feedback circuit 302. The switch 310 is configured for breaking or completing the feedback circuit 302 thus providing an electronic feedback to the installer, such as by controlling the output device 306. The switch 310 controls a current flow along the feedback circuit 302. In an exemplary embodiment, the switch 310 is a physical switch. For example, the switch 310 is a mechanical switch configured to physically move a metal contact to either break or close a circuit. The switch 310 is configured to be pressed or touched to move the contact. For example, the latch 150 may press or touch the switch 310 to activate the switch 310. The action can be completed using a toggle, lever, or button. The action can provide a tactile and/or an audible response thus providing feedback to the installer. The switch 310 may be a push button switch, a toggle switch, a rotary switch, a slide switch, a rocker switch, a piezo-switch, a capacitive switch, or another type of switch. For example, the switch 310 may include a push button that operates by pushing the button to either break or close the circuit depending on its direction. The switch 310 may include a single button as an actuation mechanism. The switch 310 may be a cost-effective feedback device.

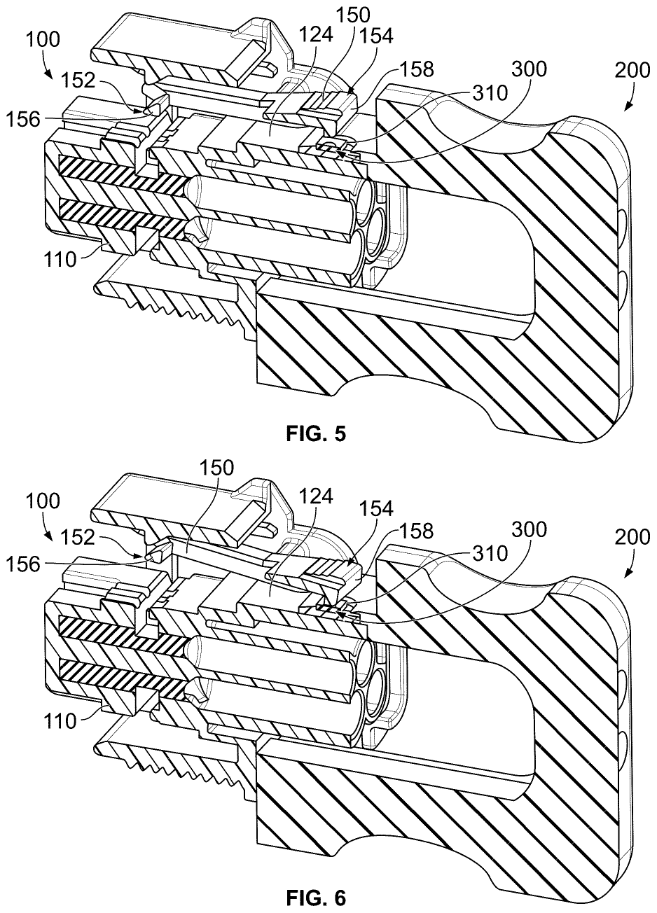

FIG. 5 is a cross-sectional view of the connector mating tool 200 coupled to the electrical connector 100 showing the latch 150 in the normal or latched position. FIG. 6 is a cross-sectional view of the connector mating tool 200 coupled to the electrical connector 100 showing the latch 150 in the actuated or unlatched position. When assembled, the connector mating tool 200 is coupled to the electrical connector 100. The latch pad 250 is received in the space between the top 124 of the housing 110 and the bottom of the latch 150. The latch pad 250 positions the latch feedback device 300 relative to the latch 150. For example, the switch 310 is aligned with the actuator 158 of the latch 150 such that the switch 310 may be activated by the latch 150 when the latch 150 is moved to the actuated position.

During installation, the latch 150 is pressed downward to actuate the latch 150 and allow the latch 150 to clear the latching element (for example, catch) of the mating electrical connector. The latch 150 is released after the latch 150 clears the latching element of the mating electrical connector to return to the normal or latched position to latchably couple to the latching element. In an exemplary embodiment, the actuator 158 at the actuating end 154 is pressed downward or actuated by the installer, which causes the latching end 152 to lift upward to clear the latching element. In other embodiments, the latching end 152 may be automatically lifted upward during installation by riding upward along the ramp of the latching element as the electrical connector 100 is pushed forward in the mating direction. Once the latching element 156 clears the catch of the latching element of the mating electrical connector, the latching end 152 returns downward into a latched position behind the catch. As the latching end 152 moves downward, the actuating end 154 moves upward to the normal position. The actuating end 154 thus moves relative to the latch feedback device 300.

The bottom of the latch 150 at the actuating end 154 is configured to engage the switch 310 in the actuated position, thus activating the switch 310. The bottom of the latch 150 at the actuating end 154 is separated from the switch 310 in the released or normal position. The switch 310 is able to determine a position of the switch 310. For example, when the switch 310 is activated by the latch 150, the latch 150 is determined to be in the unlatched position. When the switch 310 is deactivated (not activated) by the latch 150, the latch 150 is determined to be in the unlatched position.

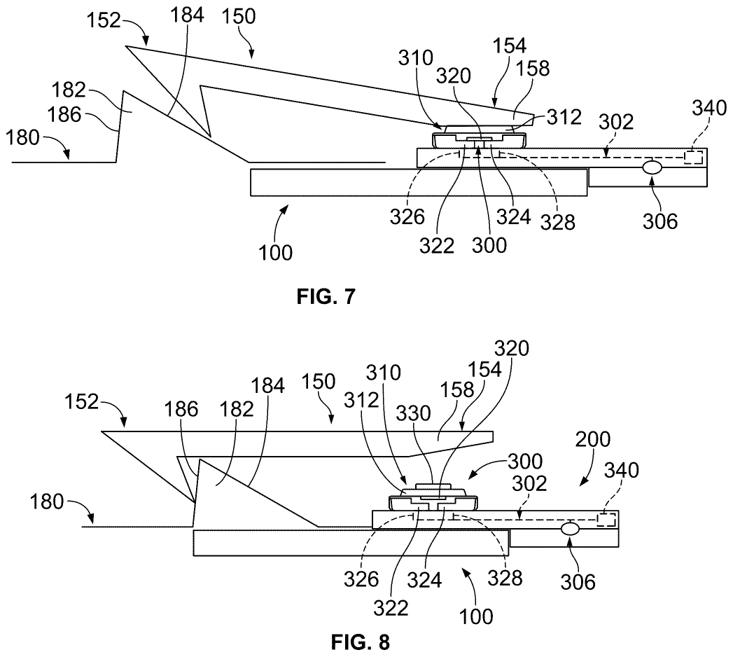

FIG. 7 is an enlarged cross-sectional view of a portion of the connector mating tool 200 and electrical connector 100 unmated from the mating electrical connector 180. FIG. 8 is an enlarged cross-sectional view of a portion of the connector mating tool 200 and electrical connector 100 mated to the mating electrical connector 180. FIG. 7 shows the latch 150 in the actuated or unlatched position, whereas FIG. 8 shows the latch 150 in the normal or latched position.

In an exemplary embodiment, the switch 310 is a push-button style switch. However, other types of switches may be used in alternative embodiments. The switch 310 includes a switch housing 312 holding a movable contact 320 and fixed contacts 322, 324. The fixed contacts 322, 324 are connected to leads or conductors 326, 328 of the feedback circuit 302. The leads 326, 328 are electrically connected to the output device 306, such as the visual indicator, to control the output device 306 based on the state of the switch 310. The movable contact 320 is movable between an open position and a closed position. The movable contact 320 is configured to electrically connect the fixed contacts 322, 324 in the closed position to close or make the feedback circuit 302. The movable contact 320 is separated from the fixed contacts 322, 324 in the open position to break or open the feedback circuit 302.

The switch 310 includes a button 330 operably coupled to the movable contact 320 to move the movable contact 320 from the open position to the closed position. The button 330 is configured to be activated by the latch 150. For example, the actuator 158 of the latch 150 engages the button 330 and presses the button 330 inward when the latch 150 is actuated.

In an exemplary embodiment, the latch feedback device 300 includes a wireless communication module 340. The wireless communication module 340 is coupled to the feedback circuit 302. The wireless communication module 340 is configured to communicate wirelessly, such as to another device, such as a computer, user work station, handheld device, or other remote device. An output signal may be transmitted by the wireless communication module 340, such as relating to the operation status of the switch 310 and/or a position of the latch 150.

As shown in FIG. 7, the bottom of the latch 150 at the actuating end 154 is configured to engage the switch 310 in the actuated position, thus activating the switch 310. The latch 150 is moved downward to actuate the latch 150 and allow the latch 150 to clear the latching element 182 (also referred to as a catch 182) of the mating electrical connector 180. For example, the actuator 158 at the actuating end 154 may be pressed downward, or actuated, by the installer, which causes the latching end 152 to lift upward to clear the latching element. Alternatively, the latching end 152 may be automatically lifted upward during installation by riding upward along a ramp 184 of the latching element 182 as the electrical connector 100 is pushed forward in the mating direction. When the switch 310 is activated by the latch 150, the latch 150 is determined to be in the unlatched position. The output device 306 may be activated by the switch 310, such as based on the position of the latch 150.

As shown in FIG. 8, the latch 150 is released after the latch 150 clears the latching element 182 of the mating electrical connector 180 to return to the normal or latched position to latchably couple to the latching element 182. For example, the latching element 156 is hooked around the catch 182 to engage a latching surface 186 of the catch 182. Once the latching element 156 clears the catch 182 of the mating electrical connector 180, the latching end 152 returns downward into a latched position behind the latching surface 186 of the catch 182. As the latching end 152 moves downward, the actuating end 154 moves upward to the normal position. The bottom of the latch 150 at the actuating end 154 is separated from the switch 310 in the released or normal position. When the switch 310 is deactivated (not activated) by the latch 150, the latch 150 is determined to be in the unlatched position. The output device 306 may be activated (or deactivated) by the switch 310, such as based on the position of the latch 150.

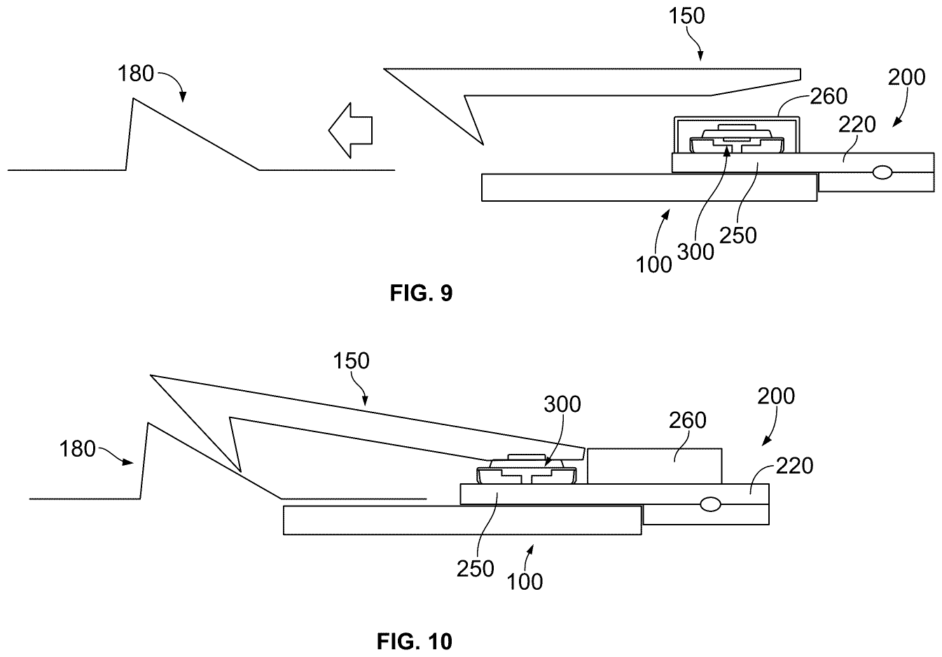

FIG. 9 is an enlarged cross-sectional view of a portion of the connector mating tool 200 and electrical connector 100 partially mated with the mating electrical connector 180. FIG. 10 is an enlarged cross-sectional view of a portion of the connector mating tool 200 and electrical connector 100 unmated to the mating electrical connector 180. FIG. 9 shows the latch 150 in the actuated or unlatched position, whereas FIG. 10 shows the latch 150 in the normal or latched position.

FIGS. 9 and 10 illustrate the connector mating tool 200 including a cover 260 configured to cover the latch feedback device 300. FIG. 9 shows the cover 260 in an open position, whereas FIG. 10 shows the cover 260 in a closed position. The cover 260 is coupled to the support arm 220 and/or the latch pad 250. The cover is movable between the covered position and the uncovered position. The cover 260 may be slidably coupled to the support arm 220 and/or the latch pad 250. The cover 260 may be pivotably coupled to the support arm 220 and/or the latch pad 250. The cover 260 may be clipped, latched or otherwise coupled the support arm 220 and/or the latch pad 250 and is removable from the support arm 220 and/or the latch pad 250. The cover 260 is configured to cover the latch feedback device 300 in the covered position. As such, the latch 150 is unable to interface with the latch feedback device 300 when covered by the cover 260. The latch feedback device 300 is accessible to interface with the latch 150 when the cover 260 is in the uncovered position.

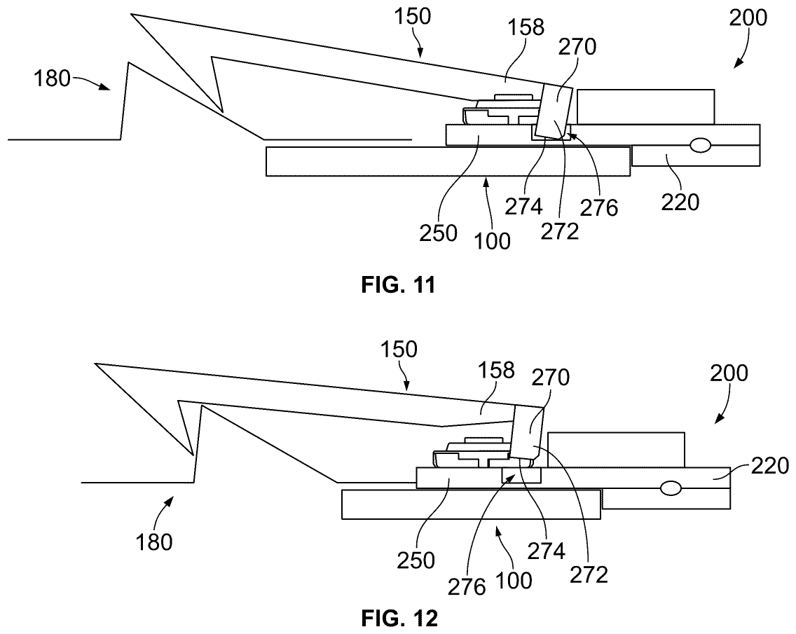

FIG. 11 is an enlarged cross-sectional view of a portion of the connector mating tool 200 and electrical connector 100 partially mated with the mating electrical connector 180. FIG. 12 is an enlarged cross-sectional view of a portion of the connector mating tool 200 and electrical connector 100 mated to the mating electrical connector 180. FIG. 11 shows the latch 150 in the actuated or unlatched position, whereas FIG. 12 shows the latch 150 in the normal or latched position.

FIGS. 11 and 12 illustrate the connector mating tool 200 including a clip element 270 configured to connect the latch 150 to the connector mating tool 200 to hold a position of the latch 150 relative to the connector mating tool 200. FIG. 11 shows the clip element 270 in a released position, whereas FIG. 10 shows the clip element 270 in a connected position. The clip element 270 extends from the latch 150 and is configured to be releasably coupled to the support arm 220 and/or the latch pad 250. For example, the clip element 270 may be integral with the latch 150 or may be coupled to the latch 150. The clip element 270 includes clip arms 272 having distal ends 274 configured to be coupled to the support arm 220 and/or the latch pad 250, such as in pockets 276 formed therein. Alternatively, the clip element 270 extends from the support arm 220 and/or the latch pad 250 and is configured to be releasably coupled to the actuator 158 of the latch 150. When the clip element 270 is used, the clip element 270 holds the latch 150 in the actuated position (FIG. 11). The clip element 270 is released when the electrical connector 100 is fully mated as the latch 150 is moved to the latched position.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A connector mating tool to assist mating an electrical connector with a mating electrical connector in a mating direction, the connector mating tool comprising:
a base;
a support arm extending from the base, the support arm including a press surface configured to engage the electrical connector and press the electrical connector in the mating direction;
a latch pad extending from the support arm, the latch pad configured to be aligned with a latch of the electrical connector; and
a latch feedback device on the latch pad configured to interface with the latch when the latch is actuated to provide feedback regarding a position of the latch.

2. The connector mating tool of claim 1, wherein the latch feedback device includes a switch configured to be activated by the latch.

3. The connector mating tool of claim 2, wherein the switch includes a movable contact and fixed contacts connected to leads, the movable contact movable between an open position and a closed position, the movable contact configured to electrically connect the fixed contacts in the closed position, the switch including a button operably coupled to the movable contact to move the movable contact from the open position to the closed position, the button configured to be activated by the latch.

4. The connector mating tool of claim 3, wherein the leads are electrically connected to a visual indicator to control the visual indicator based on the state of the switch.

5. The connector mating tool of claim 1, wherein the latch feedback device provides electronic feedback of the position of the latch.

6. The connector mating tool of claim 1, wherein the latch feedback device includes a visual indicator activated based on the position of the latch, the visual indicator providing a visual indication of an operation status of the latch feedback device.

7. The connector mating tool of claim 1, wherein the latch feedback device includes a wireless communication module configured to communicate wirelessly.

8. The connector mating tool of claim 1, wherein the latch pad includes a pocket, the latch feedback device received in the pocket.

9. The connector mating tool of claim 1, wherein the latch pad includes a ramp at a front edge.

10. The connector mating tool of claim 1, wherein the latch pad includes an upper surface, the latch feedback device being coupled to the upper surface to face the latch when the latch pad is received between the top of the electrical connector and the latch.

11. The connector mating tool of claim 1, wherein the support arm includes a finger grip for holding the connector mating tool.

12. The connector mating tool of claim 1, further comprising a second support arm extending from the base remote from the support arm with a receiving space defined therebetween, the second support arm including a second press surface configured to engage the electrical connector and press the electrical connector in the mating direction, the connector mating tool being configured to receive the electrical connector in the receiving space between the support arm and the second support arm.

13. The connector mating tool of claim 1, further comprising a cover coupled to at least one of the support arm and the latch pad, the cover movable between a covered position and an uncovered position, the cover configured to cover the latch feedback device in the covered position, the latch feedback device being accessible to interface with the latch when the cover is in the uncovered position.

14. The connector mating tool of claim 13, wherein the cover is one of slidable or rotatable between the covered position and the uncovered position.

15. The connector mating tool of claim 1, wherein at least one of the latch pad and the support arm includes a clip element configured to connect the latch to the connector mating tool to hold a position of the latch relative to the connector mating tool.

16. A connector mating tool to assist mating an electrical connector with a mating electrical connector in a mating direction, the connector mating tool comprising:
a base;
a support arm extending from the base, the support arm including a press surface configured to engage the electrical connector and press the electrical connector in the mating direction;
a latch pad extending from the support arm, the latch pad configured to be aligned with a latch of the electrical connector;
a latch feedback device on the latch pad configured to interface with the latch when the latch is actuated to provide feedback regarding a position of the latch; and
a visual indicator on one of the base or the support arm, the visual indicator being operably coupled to the latch feedback device, the visual indicator providing a visual indication of an operation status of the latch feedback device.

17. The connector mating tool of claim 16, wherein the latch feedback device includes a switch configured to be activated by the latch, the visual indicator being operably coupled to the switch.

18. The connector mating tool of claim 16, further comprising a cover coupled to at least one of the support arm and the latch pad, the cover movable between a covered position and an uncovered position, the cover configured to cover the latch feedback device in the covered position, the latch feedback device being accessible to interface with the latch when the cover is in the uncovered position.

19. A connector mating tool to assist mating an electrical connector with a mating electrical connector in a mating direction, the connector mating tool comprising:
a base;
a support arm extending from the base, the support arm including a press surface configured to engage the electrical connector and press the electrical connector in the mating direction;
a latch pad extending from the support arm, the latch pad configured to be aligned with a latch of the electrical connector;
a latch feedback device on the latch pad configured to interface with the latch when the latch is actuated to provide feedback regarding a position of the latch; and
a cover coupled to at least one of the support arm and the latch pad, the cover movable between a covered position and an uncovered position, the cover configured to cover the latch feedback device in the covered position, the latch feedback device being accessible to interface with the latch when the cover is in the uncovered position.

20. The connector mating tool of claim 19, wherein the latch feedback device includes a switch configured to be activated by the latch, the cover blocking access to the switch in the covered position.
